(19) United States
(12) Patent Application Publication
(10) Pub. No.: US 2019/0009240 A1
(43) Pub. Date: Jan. 10, 2019

(54) Apparatus Enabling High Density Information Storage in Molecular Chains

(71) Applicant: The Charles Stark Draper Laboratory, Inc., Cambridge, MA (US)

(72) Inventors: Andrew P. Magyar, Acton, MA (US); Ian Ward Frank, Arlington, MA (US); Jeffrey A. Korn, Lexington, MA (US); Neil Sunil Patel, Cambridge, MA (US)

(21) Appl. No.: 16/031,271

(22) Filed: Jul. 10, 2018

Related U.S. Application Data
(60) Provisional application No. 62/530,366, filed on Jul. 10, 2017.

(51) Int. Cl. B01J 19/00; B01L 3/00; B01J 19/12

(52) U.S. Cl. CPC B01J 19/0046; B01L 3/502715; B01J 19/127; B01J 2219/00722; B01J 2219/00587; B01J 2219/00711; B01J 2219/00317

(57) ABSTRACT

A parallelized chain-synthesizing technique includes an array of wells, each well in the array providing a location where a specific arbitrary sequence for polymeric chains can be grown. An optical addressing system selectively delivers light to the wells to mediate or control reactions in the wells.

### RELATED APPLICATIONS

This application claims the benefit under 35 USC 119(e) of U.S. Provisional Application No. 62/530,366, filed on Jul. 10, 2017, which is incorporated herein by reference in its entirety.

### BACKGROUND OF THE INVENTION

International Patent Application No. PCT/US18/33798, filed on May 22, 2018, by Magyar, et al., which is incorporated herein by this reference in its entirety (hereinafter Magyar Application), concerns the control of DNA growth. Specifically, it concerns terminal Deoxynucleotidyl Transferase (TDT or TdT) engineering, which is the control of the catalytic cycle of TDT for DNA synthesis technology. TDT is an enzyme that is capable of catalyzing the addition of nucleotide triphosphate's and analogs to the ends of strands of DNA.

The Magyar Application describes the catalytic cycle of TDT. The enzyme has two major activities during in vitro non-template DNA synthesis. These activities are transferring nucleotides onto the three-prime end of a growing DNA strand, and ratcheting down the strand of DNA in order to position the active site such that the next nucleotide can be added.

The Magyar Application presents a number of methodologies for controlling the catalytic cycle for single nucleotide insertion. There are a number of steps at which the enzyme can be engineered such that only a single base can be controllably inserted at a time. Some approaches described in this application involve control of DNA growth by modulating the temperature, pH, light or other aspects of the environment.

### SUMMARY OF THE INVENTION

Given the ability to control the growth, DNA or other polymeric chains have great promise for ultrahigh density storage of information. Current techniques for building such chains of arbitrary composition (as required for arbitrary data storage) do not enable large arrays of chains to be contained and grown in a compact apparatus and in a scalable manner, however.

The present invention concerns a parallelized chain-synthesizing apparatus comprised of arrays of wells, an array in which each well provides a location where a specific arbitrary sequence can be grown. Each well is encoded with a unique address via, for example, a piece of single-stranded DNA (SS-DNA) that seeds the growth of the payload information in the DNA. This addressing SS-DNA piece can be deposited a priori or grown as part of enzymatic process described in this invention. The seed DNA acts as a primer for PCR (polymerase chain reaction) amplification and DNA sequencing. The unique address for the well is encoded in the seed DNA.

In some examples, the wells in the array contain a single chain with data encoded via a specific sequence. Or, the well may contain multiple sequences of single-stranded DNA designed to all encode the same data, but due to the chemical kinetics may have slightly different sequences; yet because of choice of data encoder and error correction during read out will still have the same information.

Providing the necessary chemistry to each of the different wells is accomplished by dip coating or by means of microfluidics in different embodiments. The use of spatially and temporally gating an optical signal that is arbitrarily addressable to each well allows for the same sequence of raw materials to be delivered to every well simultaneously, with the optical gating determining the portion of the sequence delivered to the well that is incorporated into the chain or chains anchored in the specific well. A rinsing buffer can be delivered through the same channels that deliver the raw materials.

In general, according to one aspect, the invention features a parallelized chain-synthesizing apparatus. It comprises an array of wells, in which each well provides a location where a specific arbitrary sequence for polymeric chains can be grown, and an optical addressing system for selectively delivering light to the wells to mediate or control reactions in the wells.

In many of its aspects, the synthesis involves use of a photoswitch to induce structural changes in conformation in response to electromagnetic radiation, e.g., in the visible or ultraviolet (UV) spectral region.

Some DNA syntheses, for example, rely on engineered enzymes obtained by modifying the protein to include a (new) domain capable of blocking the nucleotide entrance tunnel, under certain conditions. Use of the CRY2-CIB1 blue-light responsive domains (or versions thereof) could give optical control over TdT's nucleotide binding activity, thus providing tight control over the enzyme's addition of nucleotides. In this scenario, blue light would cause the localization of two protein domains, which would be engineered to close up the nucleotide entrance tunnel. Therefore, in the presence of blue light, nucleotides would not be able to bind or escape from the active site of the enzyme.

In some approaches for growing DNA strands, the chain synthesis can utilize enzymes engineered for photo-gated TdT control. For instance, the engineered TdT can be photoisomerizable, by substituting one or more amino acid residues of the TdT with a non-naturally occurring amino acid comprising a photoswitchable moiety, such as an azobenzene derivative. The use of a modified TdT comprising an azobenzene photoswitch, for example, can controllably block entry or binding of nucleotides into the active site of the enzyme, thereby inhibiting, regulating or gating entry or binding of a mononucleotide to the active site of TdT.

Alternatively, or in addition to optically controlling nucleotide incorporation, optical control also can be applied at the ratcheting stage (the stage that takes place after a nucleotide has been incorporated and enables the addition of a subsequent nucleotide by moving the SS-DNA out of the catalytic region of the TdT).

Systems enabling the introduction and flushing of reactants and/or the optical stimulation of the enzyme may be added. Moreover, principles described herein can be incorporated in microfluidic or other devices and/or techniques.

Embodiments described herein are believed to address challenges presented by the rapid increase in information, an increase that appears to outpace traditional storage devices. With information being stored at the molecular level, practicing aspects of the invention can result in highly dense storage of huge amounts of information. It is estimated, for example, (Robert F. Service, Science, Mar. 2, 2017, 2:00 PM) that DNA could store all of the world's data in one room. Furthermore, polymeric chains such as DNA, if stored properly, can have exceptional longevity. DNA from the era of the dinosaurs has been decoded. Thus, unlike conventional storage media, DNA would not become obsolete or corrupted. Moreover, data stored in this form can be copied.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram illustrating the approach for using the parallelized chain-synthesizing apparatus for data encoding and storage.

FIGS. 2A and 2B are schematic diagrams illustrating how polymeric chains or DNA are encoded with information in a potentially highly parallelized fashion.

FIGS. 3A and 3B provide an overview of the enzyme engineering that enables photo-gated or mediated TDT control.

FIGS. 4A, 4B and 4C provide an overview of molecular switches for protein control, with FIG. 4A showing the trans and cis isomers of azobenzene, FIGS. 4B and 4C are based on “Bidirectional Photocontrol of Peptide Conformation with a Bridged Azobenzene Derivative”, Angew. Chem. Int. Ed. 51, 6452-6455 (2012).

FIGS. 5A and 5B are a top plan view and a side cross-sectional view of the substrate for the parallelized chain-synthesizing apparatus 100.

FIG. 6 schematically shows some other components associated with the parallelized chain-synthesizing apparatus 100.

FIG. 7 is a side cross-sectional view of the substrate for the parallelized chain-synthesizing apparatus 100 according to another embodiment.

FIGS. 8A and 8B are a schematic top view of an emitter array device 180 and a side cross-sectional view of the emitter array device 180 installed on the substrate 110, according to another embodiment.

FIG. 9 shows another embodiment in which a lens array 190 is used between the emitter array device 180 and wells 112 of the substrate 110.

FIG. 10 is a schematic view showing a system for scanning light over the wells of the substrate 110.

FIG. 11 shows another embodiment in which microfluidic manifolds are provided in the substrate.

FIG. 12 shows an example of an array of wells.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein, rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

A common technique in combinatorial chemistry, “parallel synthesis” generally refers to the preparation of chemical structure combinations by separate and parallel syntheses, using multiple, often thousands of reaction vessels. Typically, the method employs robotics programmed to add the appropriate reagents to each vessel and generates libraries based on a specific skeleton (starting compound).

In this type of combinatorial approach, compounds are synthesized in parallel and in spatially separated compartments, using a “one vessel—one compound” principle. The reactions can be conducted on a solid support or in a liquid phase (solution chemistry). In many implementations, the vessel is a 96 well microtiterplate (MTP), or another suitable array.

In many of its aspects, the present invention relates to parallelized chain-synthesizing technology that uses arrays of wells, each well providing a location where a specific arbitrary sequence can be grown. Each well can be encoded with a unique address via, for example, a piece of single-stranded DNA that seeds the growth of the payload information in the DNA. The seed DNA acts as a primer for PCR amplification and DNA sequencing. The unique address for the well is encoded in the seed DNA. Reactions in the wells are mediated, gated or controlled optically. This single strand could be deposited as part of the preparation for the growth or created de novo during growth.

A major application of this technology relates to data encoding and storing. Examples of data that can be encoded include but are not limited to electronic files, databases, manuscripts, graphics, computer programs, experimental data, spreadsheets, libraries, genetic information, and so forth, in encrypted, compressed, or un-modified from.

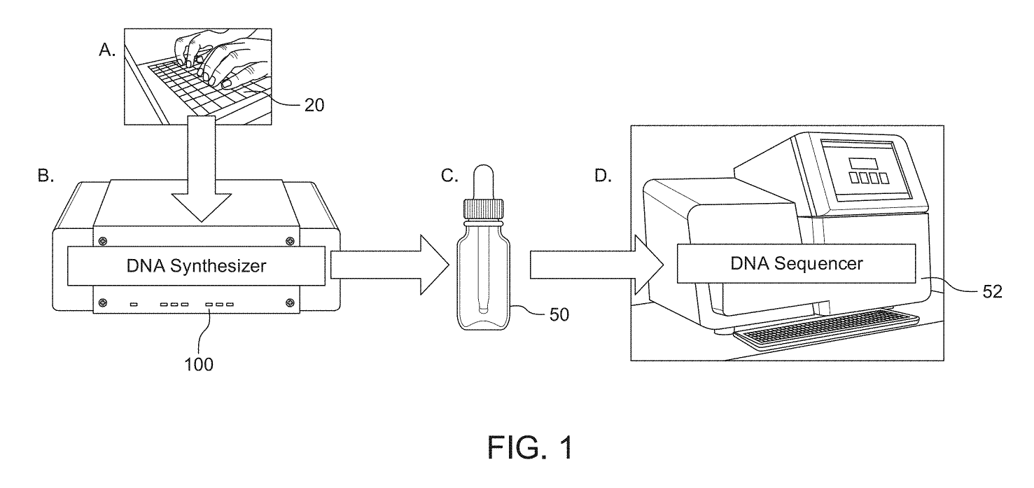

An illustrative diagram showing how parallelized chain-synthesis techniques can be used in data encoding and storage processes is provided in FIG. 1. In the download phase or stage A, data, e.g., a file, initially stored on a personal computer 20 or another suitable device, is downloaded to a parallelized chain synthesizer 100. The parallelized chain synthesizer apparatus is designed to construct, simultaneously, multiple chains that encode the information from the input data (e.g., file).

The next stage is the writing stage B, which involves encoding the file as a collection of relatively short (100-1000 base pair, for example) DNA/oligo strands that can be in an aqueous solution or another suitable medium. Encryption and error correction can be applied during synthesis.

The length of the encoded strands is determined by the write error rate, the read error rate, and spatial constraints due to the finite well size and lengths of SS-DNA.

In phase C, the collection of DNA/oligo strands are stored and/or transported, e.g., in vial 50, to a suitable destination, e.g., DNA sequencer 52, for sequencing. The sequencer can be a commercial off the shelf (COTS) apparatus, a next generation DNA sequencer, or any suitable mechanism for reading DNA sequences.

Phase D is a reading and/or recording phase during which the solution from vial 50 is processed and read-out by the DNA sequencer 52.

For illustrative purposes, stage A could take a few minutes, step C several days or even years (during long term storage), while steps B and D (write and read, respectively) could take several hours.

In some embodiments, the sequencer is provided together with the parallelized chain synthesizer apparatus, thereby minimizing or entirely bypassing the transport stage C.

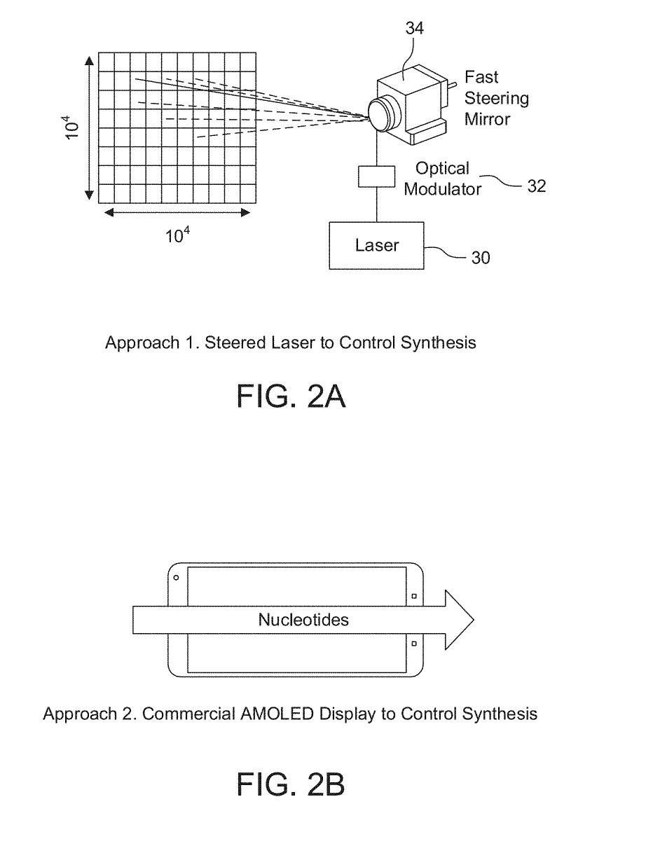

FIGS. 2A and 2B provide schematic representations describing how polymeric chains or DNA can be encoded with information and shows high-density DNA arrays for data storage. One implementation has the goal of synthesizing 1 GigaByte bite (GB) on a 10 centimeters (cm)×10 cm chip per hour.

One approach (FIG. 2A) relies on optically gated polymeric chain synthesis to generate high density areas of non-verified sequences. Nucleotides, for example, used in the building of the sequences, such as DNA, are provided to separate pixels or wells of the parallelized chain-synthesizing apparatus 100. The synthesis of the polymeric chains is mediated using an optical mechanism. The sequential flow of individual nucleotides involves writing that occurs only in pixels that are illuminated. In one implementation, light is delivered using fast steering mirrors or arrays of light emitters as are found in commodity cellular/smart phones and other similar mobile computing devices. An optical modulator 32, disposed between laser 30 and fast steering mirror 34, can be synced to activate only a desired synthesis site.

Another approach (FIG. 2B) relies on active-matrix organic light-emitting diode (AMOLED) display technology. In one implementation, the standard AMOLED display found in a typical commercially available cell phone (up to 3840×2160) is modified to control an individual synthesis reaction. The technique can be used for up to 10⁸ individually addressable sequences, each potentially 10³ nucleotides long, resulting in up to 1 GB on a single chip.

Applying commodity (commercial) technology has the potential of addressing over 8 million locations, optically. This presents the potential to simultaneously grow over 8 million separate sequences simultaneously. Alignment and registration of the optical emitters with the wells may be performed at a factory where a microstructure with apertures is aligned to the emitters, and a growth substrate with the seed DNA is placed on top.

Various compositions, methods and kits for polynucleotide synthesis that are applicable or can be adapted to the parallelized chain-synthesis techniques described herein are provided in the Magyar Application. They include, for example, methodologies for engineering the terminal deoxynucleotidyl transferase (TdT) protein/enzyme to control the addition of nucleotides to a growing nucleotide strand.

One methodology described in the Magyar application relies on the metallic control of TDT. This approach focuses on the separation of metal ion binding at different sites. If the binding at one site occurs on a condition that does not allow metal binding to another then the enzymes catalytic mechanism can be controlled such that only a single nucleotide is added at a time.

The Magyar Application further provides methods for control of conformation. Typically, a conformational change occurs during the catalytic cycle of TDT. Leucine 398 flips up intercalating between the last nucleotide on the 3-prime end of the primer strand and the rest of the strand.

Reversibly blocked entrance tunnels (be it by protein engineering, by an exogenous factor added to the solution, etc.) can enable greater control over single nucleotide incorporation.

In one scenario, a reversibly blocked TdT is used in conjunction with metal ion gating in order to give greater spatial and temporal control over DNA synthesis. In this scenario, metal gating is used to control the addition of an incoming nucleotide; nucleotide binding occurs under conditions separate from nucleotide addition. However, an addition level of control is added, as nucleotide binding can now be controlled as well via the reversibly blocked entrance tunnel. The nucleotide binding to the pocket can be gated, such that a single nucleotide is allowed to enter and bind to the active site, but cannot be incorporated due to metal ion constraints, and the nucleotide is sealed into the active site while excess nucleotide is removed from the surrounding solution. The bound nucleotide can be added by introduction of the catalytically necessary metal (or conditions), and the cycle can continue. In this method, nucleotides can also be excluded from the enzyme's active site if desired, similarly to the gated ratcheting engineering methods described in the Magyar Application, such as the azobenzene photo-switching molecular staple. Thus, again the specific control over nucleotide binding can yield an enzyme capable of being used in an array format to synthesize multiple strands of DNA with different sequences at once.

DNA growth can be controlled by modulating temperature, pH, light, or another aspect of its environment. In particular, exogenous control of protein conformation can rely on the use of a photo-activatable change in conformation. This may be done through the addition of protein domains that are responsive to exogenous control, such as the CRY2-CIB1 blue-light responsive domains (or versions thereof), that are used to give exogenous control over protein conformation, for example. Alternatively, a photo-activated staple is provided in the protein backbone. The azobenzene photoswitchable, for example, switches from trans to cis in the presence of UV light, and back to trans in the presence of visible light or heat. By stapling two parts of the protein backbone responsible for the change in protein conformation, such that the protein conformation change is directly linked to the change in conformation of the photoactivatable staple, the conformation of the protein is directly controlled by light and/or heat. Thus, the enzyme, after inserting a single base, could be locked in a non-ratcheting conformation while excess nucleoside triphosphates containing deoxyribose (dNTPs) are removed from the microfluidic, until a light signal is used to induce conformation change and force the enzyme through the rest of the catalytic cycle. In this manner, nucleotides can also be excluded from the enzyme's active site if desired. This gives greater spatial and temporal control over the enzyme's activity.

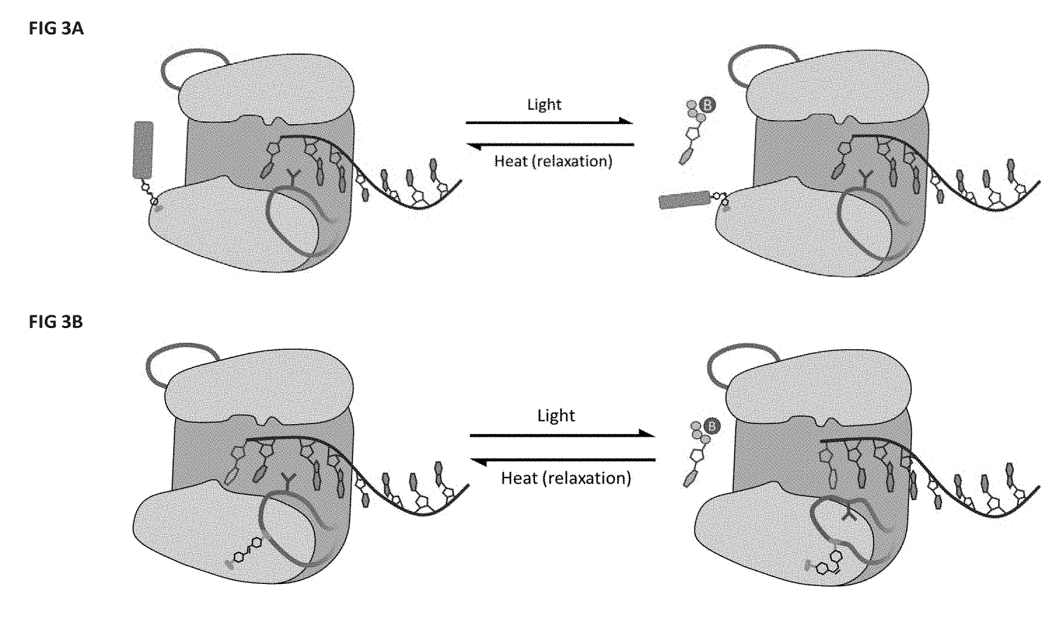

FIGS. 3A and 3B illustrate some enzyme engineering approaches that enable photo-gated or mediated TDT control.

The example of FIG. 3A involves the control of nucleotide entry based on using a “tunnel”. In this approach, a photogated molecule is employed to block the tunnel and control extension. The technique relates to the acceptance of an incoming nucleotide and, in one implementation, pertains to designing versions of TdT with a reversibly, or irreversibly, blocked nucleotide entrance tunnel, an approach that would help ensure single nucleotide addition.

Irreversibly blocked entrance tunnels for TdT enables a synthesis strategy whereby TdT is initially bound to a nucleotide, then used as a reagent for the attachment of single nucleotides to a growing DNA, and washed off by denaturing conditions. Thus, the modified TdT enzymes would become single-use, incorporating a single nucleotide before being denatured and removed.

The approach presented in FIG. 3B relies on controlling DNA ratcheting, an approach in which, after TdT performs a nucleotide incorporation, there is a restructuring of a loop in the protein, causing the DNA to ratchet, thereby enabling a subsequent base addition. This loop can be engineered to be gated by an optically controlled molecular switch.

In one example, an engineered enzyme is modified with a photoswitchable molecule. The cross-linking group will change the configuration of the loop responsible for DNA ratcheting. After extension of the DNA by TdT, the protein ratchets the DNA to enable the addition of a subsequent nucleotide. By placing the ratcheting function under photocontrol, extension of the DNA can be gated as desired.

Examples of molecular switches for protein control include molecules (e.g., azobenzene, molecules containing azobenzene moieties, other similar structures, etc.) that can induce structural changes in proteins in response to light. As a result, DNA or other polymeric chain synthesis can then be gated through the introduction of such molecules into TDT.

In more detail, an engineered (TdT) can include one or more amino acid residues of the TdT that are modified, resulting in a TdT capable of controlled addition of nucleotides to the 3′ end of a single-stranded polynucleotide. A photoisomerizable engineered TdT, for example, contains one or more amino acid residues of the TdT that are substituted with a non-naturally occurring amino acid comprising a reactive group that can be chemically crosslinked, e.g., to a photoswitchable moiety such as an azobenzene derivative. The azobenzene derivative can regulate/gate entry or binding of a mononucleotide to the active site of TdT.

Other approaches rely on a photoswitchable azobenzene moiety that is modified by the introduction of an attachment site for a click reactive group, e.g., an amine or an alcohol, and introduction of an attachment site for an amino acid side chain. The click reactive group can be selected from a pair of clickable orthogonal groups, the pair comprising: an azide-alkyne groups; tetrazine-norbornene groups; or tetrazine-trans-cyclooctene groups.

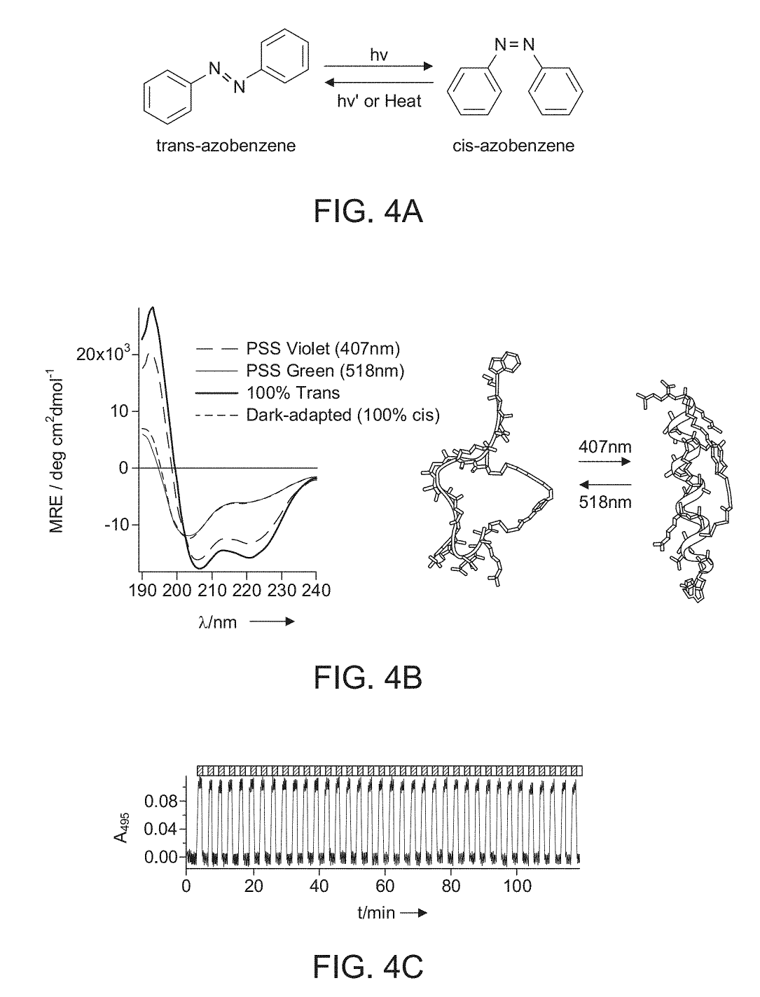

The switch from the trans to the cis isomer occurring in azobenzene exposed to light and heat is shown in FIG. 4A. Photoswitching of helical peptide conformation with bridged azobenzene derivatives is described, for instance, by S. Samanta et al. in Angew. Chem. Int. Ed. 2012, 51, 6452-6455, incorporated herein by this reference in its entirety. As seen in FIG. 4B, when an azobenzene molecule is used as to cross-link two portions of a protein, this isomerization can cause structural changes to the peptide. The plot shows the change in the circular dichromism (CD) spectrum that results from the change in ordering of the peptide as a structural change occurs. The absorption of the azobenzene at 495 nm as a function of time presented in FIG. 4C shows relatively regular oscillations from a maximum to a minimum value as it is illuminated with a regularly varying light source that enables the trans-to-cis transition at a second wavelength. Illumination actuates the transformation reducing the absorptivity of the solution containing the azobenzene and increasing the amount of light transmitted. After the illumination is extinguished, the azobenzene will thermally interact with the molecules around it and fall back to the lower energy trans state. This is one test to determine the excitation/relaxation time of the azobenzene, here the relaxation time should be faster than the desired cycle time of nucleotides so that the enzyme will transition to the correct on or off state before errors are made in either adding an unwanted nucleotide or failing to add one at the correct juncture.

An alternative approach relies on polymerase-nucleotide conjugates as described in Palluk et al., Nature Biotechnology (2018), doi:10.1038/nbt.4173 and International Publication No. WO2017/223517 A1 to D. Arlow et al., both documents being incorporated herein by this reference in their entirety. DNA synthesis is achieved using Tdt-dNTP conjugates where a nucleotide is coupled to a Tdt enzyme through a cleavable-linker in a site specific manner. The enzyme incorporates the tethered nucleotide onto the 3′ end of the DNA strand and prevents further extensions by other Tdt-dNTP molecules. In the subsequent step the Tdt is cleaved from the nucleotide by light (or a chemical agent), releasing the DNA for further extension. This cycle can be repeated to achieve the desired sequence.

In an alternative approach nucleotides with a cleavable moiety attached to the 3′-OH of the nucleotide molecule can be used with Tdt or other template independent polymerases to control DNA synthesis, as described in International Publication Nos. WO 2018/102554 A1 to Griswold et al. and WO 2017/156218 A1, to Church et al., both being incorporated herein by this reference in their entirety. This cleavable moiety can be a photolabile group such as a coumarin. The Tdt enzyme attaches the modified nucleotide to the 3′-end of the DNA, which terminates extension. In a subsequent step, the 3′-OH can be deprotected using light (or a chemical agent) enabling the addition of subsequent nucleotides. This cycle can be repeated to achieve the desired sequence.

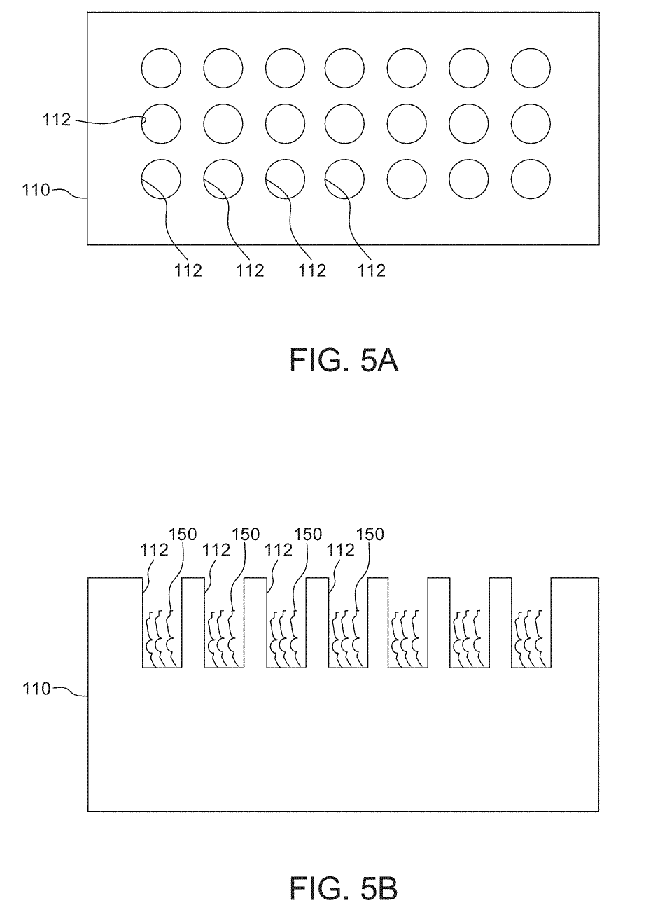

FIGS. 5A and 5B show the main component of the parallelized chain-synthesizing apparatus 100. A substrate 110 provides a series of wells 112. The polymeric chains 150 are then grown or synthesized in these wells 112, using, for example, techniques such as described above and/or in the Magyar Application.

In some examples, the wells in the array contain a single chain with data encoded via a specific sequence. In others, the well contains multiple sequences of single-stranded DNA designed to all encode the same data, but due to the chemical kinetics may have slightly different sequences; yet because of choice of data encoder, they can still have the same information.

Preferably, the wells 112 should be optically isolated from each other. This can be achieved by fabricating the substrate 110 out of a non-transmissive material. In other examples, the substrate could be transmissive but then the inner walls of each of the wells 112 would be coated with a non-transmissive substance.

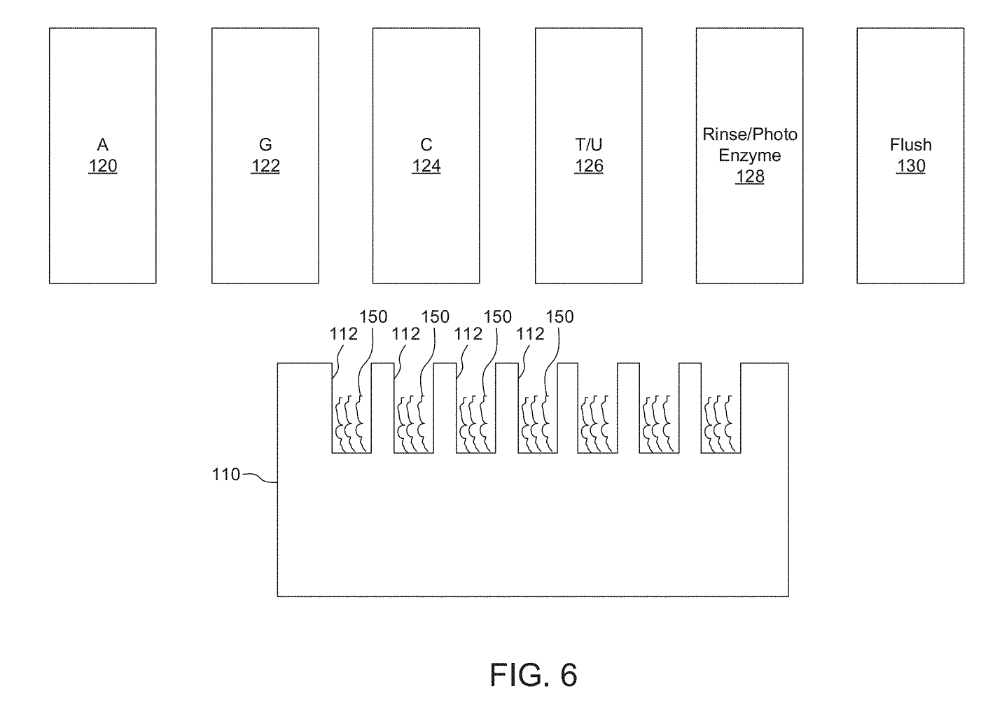

FIG. 6 shows some other components associated with the parallelized chain-synthesizing apparatus 100. As seen in this figure, each well 112 is associated with a delivery mechanism for raw materials that will become assembled into chains to form the desired sequences. In cases in which the chain is constructed from deoxyribonucleic acid (DNA) or ribonucleic acid (RNA), the raw materials include the nucleic acid bases for DNA or RNA. Each nucleotide in DNA contains one of four possible nitrogenous bases: adenine (A), guanine (G) cytosine (C), and thymine (T). RNA bases are adenine, guanine and cytosine, and uracil (U).)

In one example, the polymeric raw materials are contained in separate reservoirs. In the illustrated example, there is an adenine (A) reservoir 120, a guanine (G) reservoir 122, a cytosine (C) reservoir 124, and a thymine (T) or uracil reservoir 126.

One or more additional reservoirs can provide rinse, buffering, and photo enzyme. Specifically, there are one or more buffer or rinsing solutions and enzymatic or chemical release mechanism reservoirs 128 that can facilitate the chemistry and/or detach a finished sequence and/or deliver it for further processing or storage. A flush reservoir 130 also can be included. As with the raw materials reservoirs, reservoirs 128 and 130 are connected to each well 112.

In the illustrated embodiment, the polymeric chains are built up in the wells by providing the raw materials into the wells possibly in the form of dip coating. Specifically, the substrate 110 would be sequentially placed in any of the reservoirs 120-130 in order to step through the process of building the chains 150 in each of the wells 112. The substrate is gripped in a manner that does not interfere with liquid impinging on the growth wells. Reservoirs 120-130 are large enough to accommodate the substrate's 110 complete submersion or the substrate 110 is placed face first inside a shallow layer of liquid deep enough to fill the reaction wells and surface tension keeps the liquid inside the wells as the substrate 110 is removed from the reservoir.

In operation, the building of the chains 150 with their individualized sequence corresponding to each of the wells 112 is controlled or mediated, using photons of specific wavelengths. The photons are separately delivered to each well 112 for gating the building of the sequences.

Various strategies can be used to deliver the photons.

A first strategy relies on using a single light source with the beam expanded to address all the wells when the light source is turned on. Each well is provided with a filter or shutter for this light source. Each filter can be turned on and off independently of the filters for the other wells. This could be accomplished, for instance, with polarized light and liquid crystal cells above each well acting as a filter. An alternative approach relies on conventional micro-mirror/shutter technology as is typically found in the Micro-Electro-Mechanical Systems (MEMS) industry.

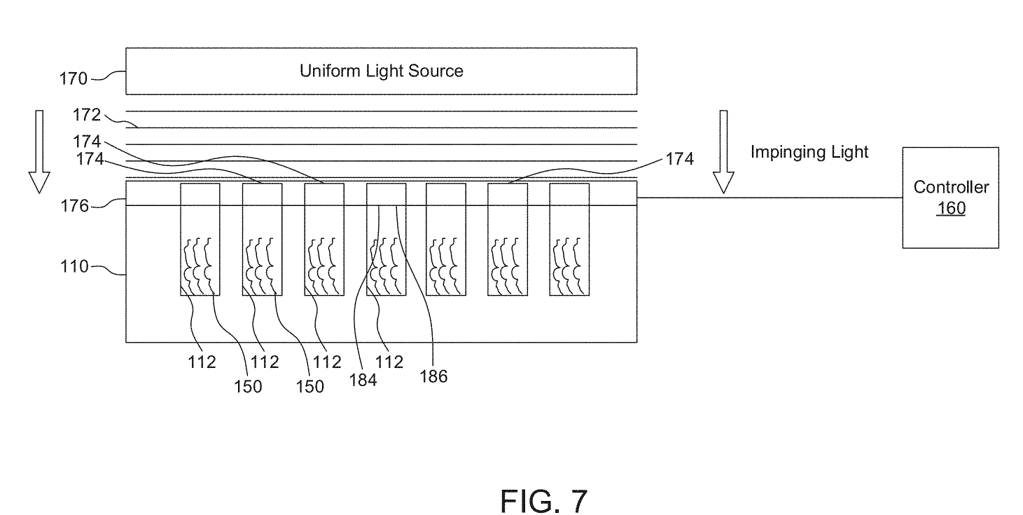

Thus, according to this (first) strategy, the wells are gated by controlling the filter, switching it on and off. An illustration is shown in FIG. 7. In this example, a filter array 176, comprising an array of filters 174, is placed over the substrate 110. There is a different filter 174 for each of the wells 112.

A light source 170 emits light 172 that is received by the filter array 176. In specific implementations, the light source 170 generates a diffuse, even illumination across the extent of the substrate 110 so that each of the filters 174 sees the same illumination level. In one example, filters 174 have varying opacity allowing the light or blocking it from entering the wells.

A controller 160 controls the filter array 176 and, specifically, the separate filters 174. The controller 160 dictates whether each of the filters 174 is transmissive or not at each step of the building of the chains 150 in each of the wells 112. In this manner, the controller 160 dictates the sequence that is being encoded into those chains 150, separately, in each of the wells 112.

In one example, the light source 170 generates polarized light. The filter array 176 is a pixelated liquid crystal display, as would be found on many flat-panel display devices. As a result, each of the filters 174 can be switched between a transmissive and non-transmissive state by the controller 160 and thus the controller 160 can mediate the reactions taking place in the wells 112 to control and dictate the sequence of the chains 150 being grown in those wells.

In a second strategy, an array of light emitters such as light emitting diodes (LEDs), or organic light emitting diodes (OLEDs), can be placed above the array of wells, such that for each well an emitter of appropriate wavelength is proximal or adjacent to the mouth of the well. Here, the apparatus could include partitions between the wells such that crosstalk or photons from the light sources impinging on the incorrect well would be minimized. Arrays of such light emitters can be found, for instance, in some cell phone/mobile computing devices' touchscreen displays.

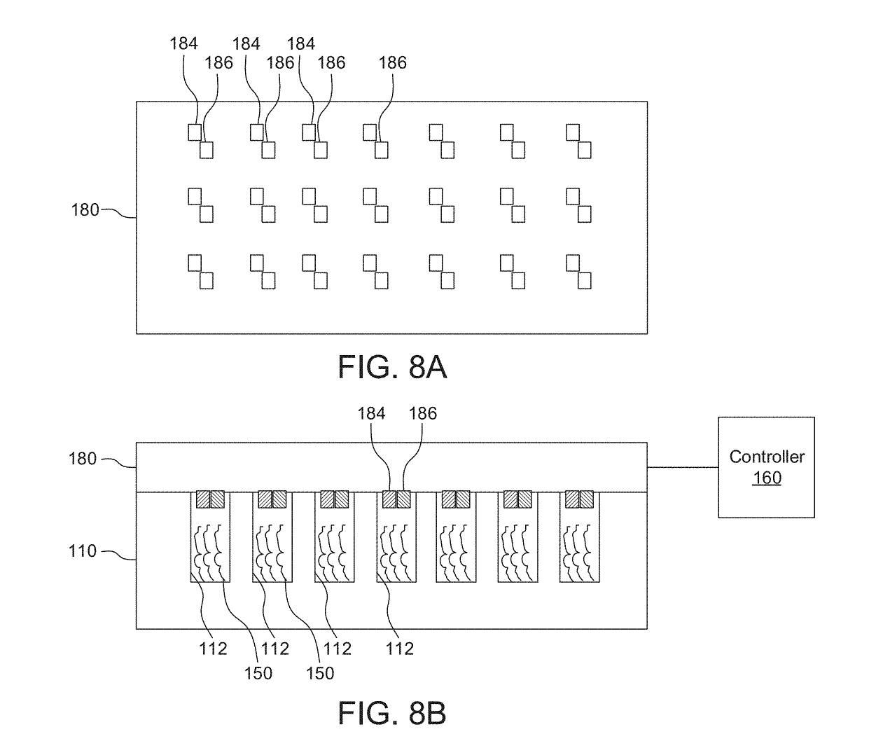

An example of this second strategy is illustrated in FIGS. 8A and 8B. Shown in FIG. 8A is a top view of a two-dimensional array of light emitters provided on an emitter array device 180. The light emitters 184, 186 of the emitter array device 180 are arranged as pixels that correspond to the array of wells 112 in the substrate 110.

FIG. 8B is a cut-away view through one row of wells, with light emitters flipped above the wells 112, containing growing sequences 150. As shown in FIG. 8B, when the emitter array device 180 is placed over the well substrate 110, the separate light emitters 184, 186 can be activated by the controller 160.

In one example, the emitter array device 180 is a commodity OLED display using thin-film encapsulation (TFE) display technology that contains an organic material which emits light when current is passed through it.

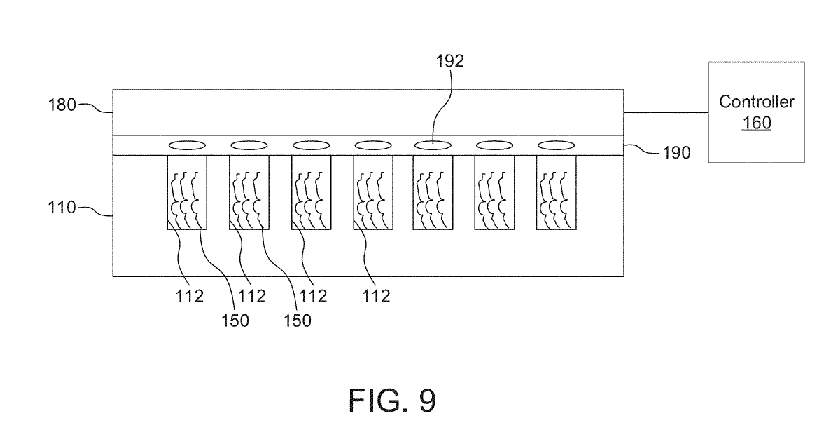

FIG. 9 shows another embodiment in which a lens array 190 is used between the emitter array device 180 and wells 112 of the substrate 110. A separate lens 192 is located over each of the wells 112, e.g., to ensure that the light generated by the separate pixels of the emitter array device 180 are efficiently directed toward the corresponding well. This prevents cross talk between the wells and thus improves the fidelity with which the sequences are controlled in the different wells.

In a third strategy, a single light emitter for each required wavelength is provided in conjunction with an optical scanning system. The scanning system, in one example, includes arrays of refractive or diffractive optics to steer the beam from the light emitters and raster scans the beams across each well that is slated to receive photons at any given juncture or point in time.

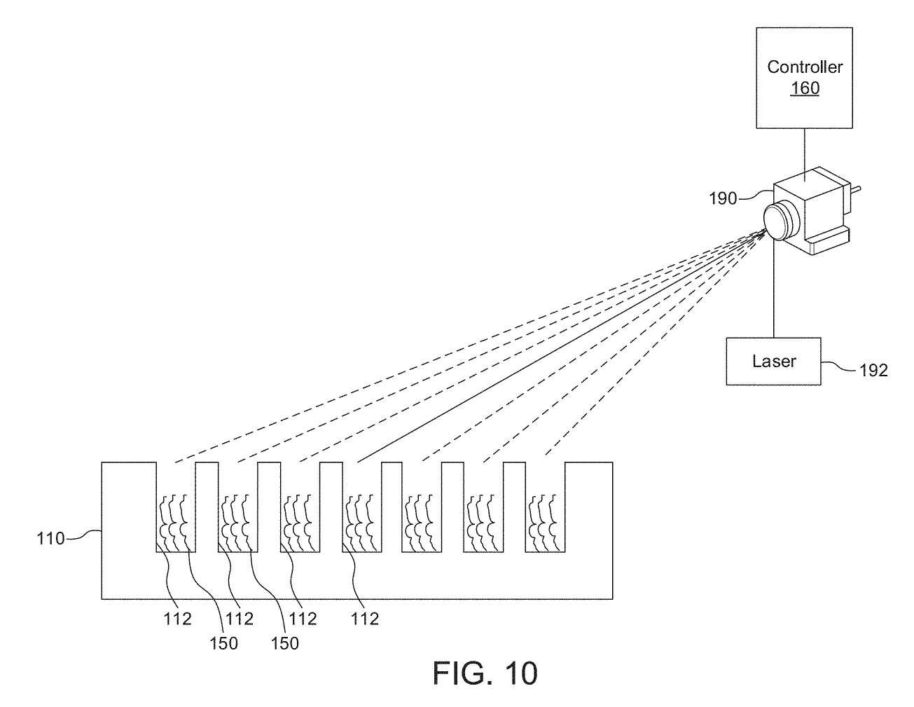

An illustration of this (third) strategy is presented in FIG. 10. A collimated light beam such as one produced by a laser 192 is scanned over the wells 112 by a scanning mirror device 190, e.g., a fast scanning mirror device) that is controlled by the controller 160. In this manner, each of the wells 112 can be separately addressed and illuminated to control and optically mediate the chain 150 being grown in that well.

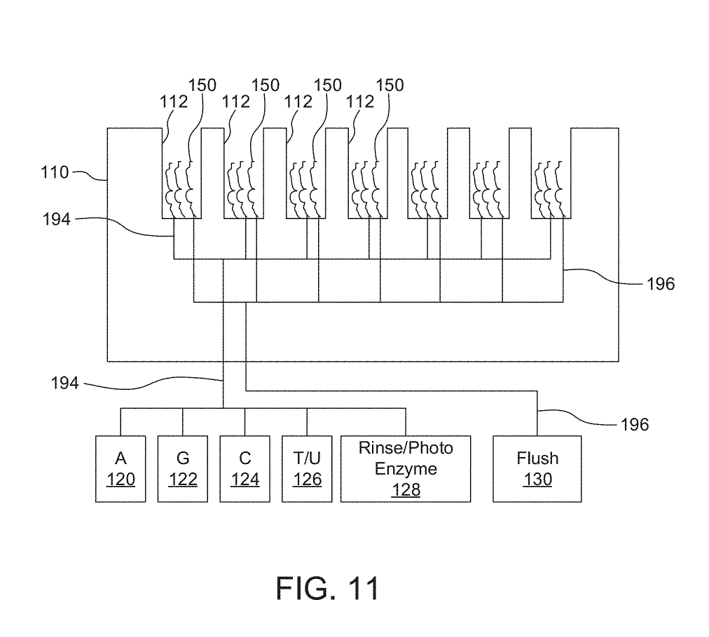

Principles described herein can be coupled with microfluidic techniques and devices. Some embodiments, for instance, incorporate microfluidic conduits and delivery/removal systems, including valves and other manifold components typically encountered in microfluidic technology. For example, as illustrated in FIG. 11, microfluidic channels can be used to deliver the polymer precursors, buffers, rinses and/or other chemicals sequentially or simultaneously to the separate wells 112.

Specifically, the polymeric raw materials are contained in separate reservoirs. In the illustrated example, there is adenine (A) reservoir 120, guanine (G) reservoir 122, a cytosine (C) reservoir 124, and a thymine (T) or uracil reservoir 126. These reservoirs are connected to the separate wells 112 through microfluidic manifolds constructed in the substrate 110, or constructed in a second, optically transmissive substrate bonded to the surface of substrate 110, either directly to the reaction wells or on the opposite face, potentially with through substrate vias providing a delivery mechanism to the reaction wells. Specifically, in the illustrated example, there is a delivery manifold 194 for supplying the chemicals to the wells 112, and a removal manifold 196 for evacuating the chemicals after the photo mediated reactions have taken place.

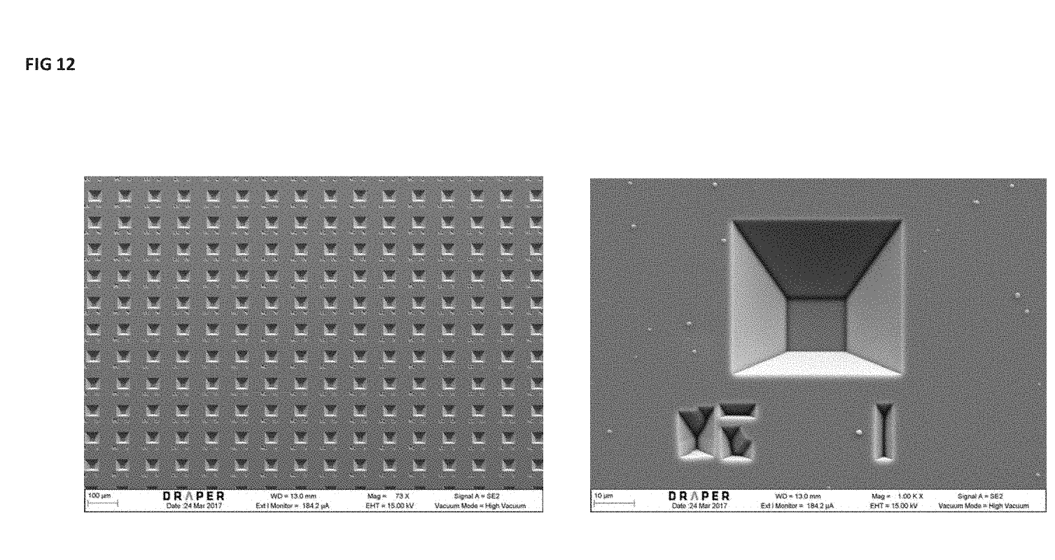

FIG. 12 shows one particular embodiment of the wells for wells on a 100 micrometer pitch. The zoom on the right shows more detail, straight sidewalls are due to a 25% TMAH etch that has a much lower etch rate on the silicon <111> crystallographic plane. These wells are etched into <100> silicon using SiO₂ as an etch mask. If the etch has been allowed to self terminate the well would have been an inverted tetrahedron but due to a timed stop the bottom is left as flat to accommodate a growth region where SS-DNA can be bound and optically addressed. International Publication No. WO 2017/222710 A1, to I. W. Frank et al., incorporated herein by this reference in its entirety, describes methods for forming such wells in which molecular chain assembly takes place.

While this invention has been particularly shown and described with references to preferred embodiments thereof, it will be understood by those skilled in the art that various changes in form and details may be made therein without departing from the scope of the invention encompassed by the appended claims.

What is claimed is:

1. A parallelized chain-synthesizing apparatus, comprising:
an array of locations for growing different arbitrary sequences for polymeric chains; and
an optical addressing system for selective delivery of light to the locations to mediate or control chemical reactions for the growth of the different sequences at the locations.

2. The parallelized chain-synthesis apparatus of claim 1, wherein the polymeric chains are DNA strands.

3. A microfluidic device comprising the chain-synthesis apparatus of claim 1.

4. A parallelized chain-synthesizing apparatus, comprising an array of wells, wherein each well provides a location for growing a specific arbitrary sequence for polymeric chains and each well is provided with an optical filter or shutter, each optical filter or shutter being configured to independently allow or block radiation from a light source.

5. The parallelized chain-synthesizing apparatus of claim 4, wherein the optical filter or shutter is provided in a filter array.

6. The parallelized chain-synthesizing apparatus of claim 5, wherein light from the light source is polarized and the filter array is a pixilated liquid crystal array.

7. A parallelized chain-synthesizing apparatus, comprising an array of wells, each well providing a location for growing a specific arbitrary sequence for polymeric chains, and an array of light emitting diodes, wherein a diode in the array of diodes is coupled with a well in the array of wells.

8. A parallelized chain-synthesizing apparatus, comprising an array of wells, each well providing a location for growing a specific arbitrary sequence for polymeric chains, and an array of light emitting diodes, wherein each light emitting diode is arranged to illuminate a single well.

9. The parallelized chain-synthesizing apparatus of claim 8, wherein the light emitting diodes are organic light emitting diodes.

10. A parallelized chain-synthesizing apparatus, comprising an array of wells, each well providing a location for growing a specific arbitrary sequence for polymeric chains, a light source and a light scanning system for independently illuminating each well in the array.

11. The parallelized chain-synthesizing apparatus of claim 10, wherein a lens is disposed over each well.

12. A parallelized chain-synthesizing apparatus, comprising:
a microfluidic device containing an array of locations, wherein sequences of polymeric chains are grown at each location; and
an optical addressing system for selective delivery of light to the locations to mediate or control chemical reactions at the locations, wherein the optical addressing system includes:
an optical filter or shutter being configured to independently allow or block radiation to each location,
an array of light emitting diodes, wherein a diode in the array of diodes is coupled with a location in the array of locations, or
a system for scanning light from a light source and independently illuminating each location in the array.

13. A parallelized chain-synthesizing apparatus, comprising:
an array of wells, in which each well provides a location for growing a specific arbitrary sequence for polymeric chains;
an optical addressing system for selective delivery of light to the wells to mediate or control chemical reactions in the wells;
one or more reservoirs for delivering or removing ingredients to or from the wells; and
microchannels connecting the one or more reservoirs to each well.

14. A system for data storage comprising:
a parallelized DNA chain-synthesizing apparatus that includes:
an array of wells, in which each well provides a location for growing a specific arbitrary sequence for polymeric chains, and
an optical addressing system for selective delivery of light to the wells to mediate or control chemical reactions in the wells; and
a DNA sequencing apparatus for decoding the polymeric chains.

15. A parallelized chain-synthesis method, comprising:
controlling or mediating chemical reactions in an array of wells by selective delivery of light to the wells,
wherein each well provides a location for growing a specific arbitrary sequence for polymeric chains.
